(19) United States
(12) Patent Application Publication
(10) Pub. No.: US 2025/0319857 A1
(43) Pub. Date: Oct. 16, 2025

(54) ELECTROMECHANICALLY OPERABLE BRAKE ACTUATOR

(71) Applicant: ZF Active Safety GmbH, Koblenz (DE)

(72) Inventor: Volker Knop, Ulmen (DE)

(73) Assignee: ZF Active Safety GmbH, Koblenz (DE)

(21) Appl. No.: 19/176,313

(22) Filed: Apr. 11, 2025

(30) Foreign Application Priority Data
Apr. 15, 2024 (DE) 102024110537.2

(51) Int. Cl. B60T 13/74; F16D 55/00; F16D 55/226; F16D 65/00; F16D 65/18; F16D 121/24; F16D 125/40

(52) U.S. Cl. CPC B60T 13/746; F16D 55/226; F16D 65/0068; F16D 65/18; F16D 2055/0016; F16D 2121/24; F16D 2125/40

(57) ABSTRACT

An electromechanically operable brake actuator for a motor vehicle disc brake is disclosed, comprising: a brake caliper housing having a recess with a first rolling bearing seat; a brake piston mounted axially movably in the recess and having an inner side facing towards an interior, at least one internal thread flight being formed into the inner side; a drive spindle which has a threaded portion with at least one external thread flight, has a shaft and has a second rolling bearing seat arranged in a transition region from the shaft to the threaded portion. The at least one external thread flight is operatively connected in terms of drive to the at least one internal thread flight such that the drive spindle and the brake piston act together as a spindle drive, and such that the brake piston can be moved axially between a retracted position and an extended position. A rolling bearing is also included, which is arranged between the first and the second rolling bearing seat, the rolling bearing being situated within the interior when the brake piston is in the retracted position.

### CROSS-REFERENCE TO RELATED APPLICATIONS

This application claims priority to German Patent Application No. 102024110537.2, filed Apr. 15, 2024, the disclosure of which is incorporated herein by reference in its entirety

### TECHNICAL FIELD

The present disclosure relates to an electromechanically operable brake actuator for a motor vehicle disc brake. The disclosure also relates to a motor vehicle disc brake having a brake actuator of said type and having an electromechanical drive. The disclosure also relates to a brake system having a motor vehicle disc brake of said type.

### BACKGROUND

As is known, electromechanically operable brake actuators are used to axially movably support a brake piston that is received in a recess of a brake caliper housing, and to make said brake piston operable by an electromechanical drive. The brake piston can thus transmit an operating force to brake pads, which can in turn press with a pressing force against a brake rotor and brake the latter. The axial movement of the brake piston is commonly effected by a recirculating ball screw drive, which is installed in part in the brake piston. In known solutions from the prior art, a spindle nut that is connected to the brake piston performs the function of retaining the balls of the recirculating ball screw drive in a circuit, and of effecting a return movement of the balls. The spindle nut is designed to be open at its two end faces, because its axial translational travel means that it must allow a passage through the spindle. Such a brake actuator is disclosed for example in DE 10 2022 119 399 A1. A disadvantage of this solution is that the spindle extends through the spindle nut at the side facing towards the brake pads, and the brake piston must therefore be designed to be of appropriate length. That is to say, sufficient space must be provided in the brake piston for that end of the spindle which projects through the spindle nut. The prior art also includes electromechanically operable brake actuators, in which the function of the ball return guide is performed by the spindle. Such a solution is disclosed for example in DE 10 2022 119 397 A1.

### SUMMARY

What is needed is to provide an electromechanically operable brake actuator for a motor vehicle disc brake, which brake actuator is optimized in terms of structural space, functional accuracy and costs. Further, a correspondingly optimized motor vehicle disc brake and a correspondingly optimized brake system are also needed.

A brake actuator is proposed herein, as well as a motor vehicle disc brake, and a brake system.

In one exemplary arrangement, an electromechanically operable brake actuator according to the disclosure is provided for a motor vehicle disc brake and has a brake caliper housing. Where the following description uses merely the term “brake actuator” for improved legibility, without this being preceded by the expression “electromechanically operable”, this is always to be understood to mean an electromechanically operable brake actuator.

The brake caliper housing has a recess delimited by a recess wall, which extends into the brake caliper housing, and by a recess base, the recess having a recess opening situated opposite the recess base. The recess base has a shaft leadthrough and a first rolling bearing seat.

The brake actuator furthermore has a brake piston, which is mounted axially movably in the recess and is in direct contact with the recess wall. The brake piston has an end wall, with which the brake piston projects out of the brake caliper housing through the recess opening. In one exemplary arrangement, the end wall is formed as a closed end wall. That is to say, such a closed end wall is firstly suitable for transmitting an actuating force to a brake pad assembly, and secondly, the end wall can be of closed form because, even though it is the case according to the disclosure that the brake piston also functions, as it were, as a spindle nut, the spindle does not extend through said brake piston, as will be described in more detail further below. The brake piston furthermore has a brake piston wall, which surrounds an interior and which has an inner side facing towards the interior, at least one internal thread flight being formed into the inner side.

The brake actuator also comprises a drive spindle which has a threaded portion with at least one external thread flight, has a shaft which projects through the shaft leadthrough, and has a second rolling bearing seat arranged in a transition region from the shaft to the threaded portion, the at least one external thread flight being operatively connected in terms of drive to the at least one internal thread flight such that the drive spindle and the brake piston act together as a spindle drive, and such that the brake piston can be moved axially between a retracted position and an extended position.

The brake actuator furthermore has a rolling bearing, which is arranged between the first and the second rolling bearing seat, the rolling bearing being situated within the interior when the brake piston is in the retracted position. Firstly, for example owing to the internal diameter of the interior or of the inner side, the interior of the brake piston is large enough in terms of its cross section (that is to say as viewed transversely with respect to the longitudinal axis of the brake piston) to accommodate both the drive spindle and the rolling bearing, for example. Secondly, the rolling bearing is also positioned axially in the interior when the brake piston is in the retracted position. In one exemplary arrangement, the rolling bearing is positioned axially entirely in the interior when the brake piston is in the retracted position. The retracted position is assumed at least when, in the case of the brake actuator having been installed in a disc brake, the brake disc in question is equipped with new, that is to say unworn brake pads, and when there is an air gap between the brake disc and the brake pads, or even also when the new brake pads are in contact with the brake disc. The positioning of the rolling bearing within the interior, for example when the rolling bearing is situated entirely within the interior, results in a shortening of the structural length of the brake actuator. The brake piston, which in this case itself performs the function of the spindle nut, can be formed with a closed end face, and can also receive the rolling bearing in the retracted position, because the balls of the recirculating ball spindle drive are supplied in the spindle or by the spindle to their circuit, and that region of the drive spindle which accommodates the balls is thus shortened in terms of structural length.

The expression “axial” or in an “axial direction” relates to the direction of extent of the recess into the brake caliper housing and to the direction of movement of the brake piston towards or away from an associated brake disc when the brake actuator has been installed in a disc brake. That is to say, the axial direction extends transversely to the braking surfaces of an associated brake disc.

In one exemplary arrangement, the at least one internal thread flight has a first raceway profile, and the at least one external thread flight has a second raceway profile. For example, either the first raceway profile or the second raceway profile may be designed as a Gothic pointed arch. In one exemplary arrangement, both the first raceway profile and the second raceway profile are designed as Gothic pointed arches. Since the brake piston itself has the internal thread flight, which is formed in the inner side of the piston, precise axial guidance and radial guidance of the brake piston relative to the drive spindle is important. Between the brake piston and the brake caliper housing, that is to say the recess wall, there is no additional component that could for example compensate running inaccuracies between the drive spindle and the spindle nut (that is to say the brake piston). Therefore, in the design according to the disclosure of the recirculating ball spindle drive, precise guidance by the Gothic pointed arch profile is particularly advantageous. A characteristic of such a Gothic pointed arch profile is that the running surfaces (flanks) on which the balls of the recirculating ball spindle drive roll have, in cross section, a radius of curvature larger than the radius of the balls. Owing to this design, the brake piston runs without play and uniformly relative to the drive spindle.

In one exemplary arrangement, the rolling bearing has a first bearing disc having a first abutment surface and having a first raceway surface, wherein the first abutment surface lies against the first rolling bearing seat, and wherein rolling elements comprised by the rolling bearing can roll on the first raceway surface. In this exemplary arrangement, the rolling bearing also has a second bearing disc having a second abutment surface and having a second raceway surface, wherein the second abutment surface lies against the second rolling bearing seat, and wherein the rolling elements comprised by the rolling bearing can roll on the second raceway surface. In this exemplary arrangement, the first abutment surface and the first raceway surface or the second abutment surface and the second raceway surface are oriented orthogonally to the axial direction. Alternatively, the first abutment surface and the first raceway surface and the second abutment surface and the second raceway surface are oriented orthogonally to the axial direction. The advantage of this arrangement, and more specifically of the exemplary arrangement in which the first abutment surface and the first raceway surface and the second abutment surface and the second raceway surface are oriented orthogonally to the axial direction, consists in that it results in a smaller axial structural space requirement. The axial support achieved here is ideal, leading to high functional accuracy of the brake actuator.

In an alternative exemplary design variant, the rolling bearing has a first bearing disc having a first abutment surface, which lies against the first rolling bearing seat, and having a first raceway surface, on which the rolling elements comprised by the rolling bearing can roll. In this design variant, the second rolling bearing seat has a second raceway surface on which the rolling elements comprised by the rolling bearing can roll. In this design variant, the rolling elements roll directly on the second raceway surface of the second rolling bearing seat. Whereas it is the case in the arrangement described further above that the second raceway surface is part of a second bearing disc, it is the case in this alternative design variant that the second raceway surface is part of the transition region of the drive spindle. That is to say, the second raceway surface is integrally connected to the drive spindle. A second bearing disc is not required here. In this alternative design variant, the first abutment surface and the first raceway surface or the second raceway surface are oriented orthogonally to the axial direction, or the first abutment surface and the first raceway surface and the second raceway surface are oriented orthogonally to the axial direction. This alternative design variant also yields the aforementioned advantages in terms of an axial shortening of structural space and in terms of functional accuracy. Furthermore, this variant of the disclosure also constitutes an inexpensive solution owing to the elimination of parts.

In conjunction with the orthogonal arrangement of the various surfaces mentioned, and in conjunction with the reduction of parts, the virtually play-free ball guidance that arises owing to the Gothic pointed arch profile is of particular benefit, because the ability to compensate running inaccuracies in these regions is reduced owing to the orthogonal arrangement and owing to the reduction of parts. Virtually play-free ball guidance means that a small degree of axial play is allowed in the unloaded state. In the loaded state, the external and internal threads are automatically centred by the balls owing to the Gothic geometry. Radial play is thus eliminated.

The recess base has a surface portion facing towards the recess and has a projection. The projection extends into the recess, and in this case the projection comprises the first rolling bearing seat. Here, the first rolling bearing seat is situated closer to the recess opening than the surface portion. This exemplary arrangement contributes to the axial shortening of structural space, and assists in the reduction of components, for example the elimination of a second bearing disc, because the rolling bearing seat is relocated in the direction of the brake piston.

In one exemplary arrangement of the disclosure, the projection is cylindrical and the surface portion is arranged annularly around the projection.

In a further exemplary arrangement of the disclosure, the projection has the shaft leadthrough. That is to say, the shaft leadthrough extends through the projection.

The first rolling bearing seat may have a support surface for directly supporting the rolling bearing, wherein the support surface is situated entirely within the interior when the brake piston is in the retracted position. This also contributes to an axial reduction of structural space of the brake actuator. Here, the first rolling bearing seat is formed integrally with the brake caliper housing. The fact that the first rolling bearing seat is formed integrally with the brake caliper housing is furthermore may also be for all described arrangements of the present disclosure. This is particularly effective in achieving a reduction of structural space (both in an axial and in a radial direction) and an optimization of costs.

The motor vehicle disc brake according to the disclosure comprises a brake carrier, comprises an electromechanical drive that has a gearbox assembly and an electric motor, and comprises a brake actuator according to any one of the above-described exemplary arrangements that is operable by the electromechanical drive. The motor vehicle disc brake furthermore comprises an electrical control unit for controlling the electric motor. The advantages and effects of the above-described exemplary arrangements of the brake actuator correspondingly also apply to the motor vehicle disc brake. In conjunction with the closed end face of the brake piston which functions as a spindle nut, the electrical control unit assists in operating the brake actuator precisely, such that a collision between the drive spindle and brake piston is avoided.

In one exemplary arrangement, the motor vehicle disc brake is constructed such that the electric motor has an output shaft, and such that the output shaft and the drive spindle extend parallel to one another and are spaced apart from one another. The output shaft and drive spindle may be spaced apart from one another such that the electric motor and the brake caliper housing axially overlap. In the case of a coaxial arrangement of the output shaft and drive spindle, the electric motor and the drive spindle would have to be arranged in line with one another in the axial direction, and the electric motor and the brake caliper housing would therefore also at least in part have to be arranged axially in line with one another. By contrast, the present disclosure, with the combination of the arrangement of the electric motor and of the brake actuator according to any one of the exemplary arrangements described above or the combination of said exemplary arrangements, offers an axially space-saving solution.

The brake system according to the disclosure comprises a motor vehicle disc brake according to the above description and comprises at least one electronics component, for example a data processor, wherein the electronics component is configured or configurable to control the electric motor such that the brake piston can be moved into the retracted position. The advantage lies in the fact that the system can be programmed such that the retracted position can be assumed exactly. Ideally, the electronics component may be configured or programmed such that a movement ramp is passed through up until the point at which the retracted position is reached, in order that collisions or excessive component loads are avoided. Analogously, the electronics component may alternatively or additionally be configured such that the brake piston can be moved into the extended position.

The brake system may be constructed such that the electronics component is comprised by the electrical control unit. This results in very short signal propagation times, whereby, in turn, the retracted position and/or the extended position of the brake piston is precisely assumed. This also contributes to a cost reduction.

The electric motor may be an electronically commutated DC motor, that is to say a brushless DC motor. In the present case, this is also conducive to the aforementioned retracted and extended positions of the brake piston being precisely assumed, which is advantageous in the case of the reduced axial structural length of the brake actuator according to the disclosure.

With regard to all exemplary arrangements of the disclosure that have been described above, the rolling bearing may be an axial rolling bearing, and in one exemplary arrangement, an axial roller bearing.

### BRIEF DESCRIPTION OF THE DRAWINGS

Further features, advantages and possible uses of the present disclosure will become apparent from the following description of the exemplary arrangements and from the schematic FIGS. 1 to 4. For the sake of clarity, it is not always the case that all of the elements illustrated in a figure are also denoted by a reference sign. Corresponding elements or regions are however then labelled at least in one other figure, from which the meaning is then apparent. Furthermore, in the figures, the same reference signs may also be used for identical or similar objects.

FIG. 1 shows a first exemplary arrangement of the brake actuator according to the disclosure.

FIG. 2 shows a second exemplary arrangement of the brake actuator according to the disclosure.

FIG. 3 shows a third exemplary arrangement of the brake actuator according to the disclosure, an exemplary arrangement of the motor vehicle brake disc according to the disclosure, and an exemplary arrangement of the brake system according to the disclosure.

FIG. 4 shows an exemplary arrangement of a Gothic raceway profile.

### DETAILED DESCRIPTION

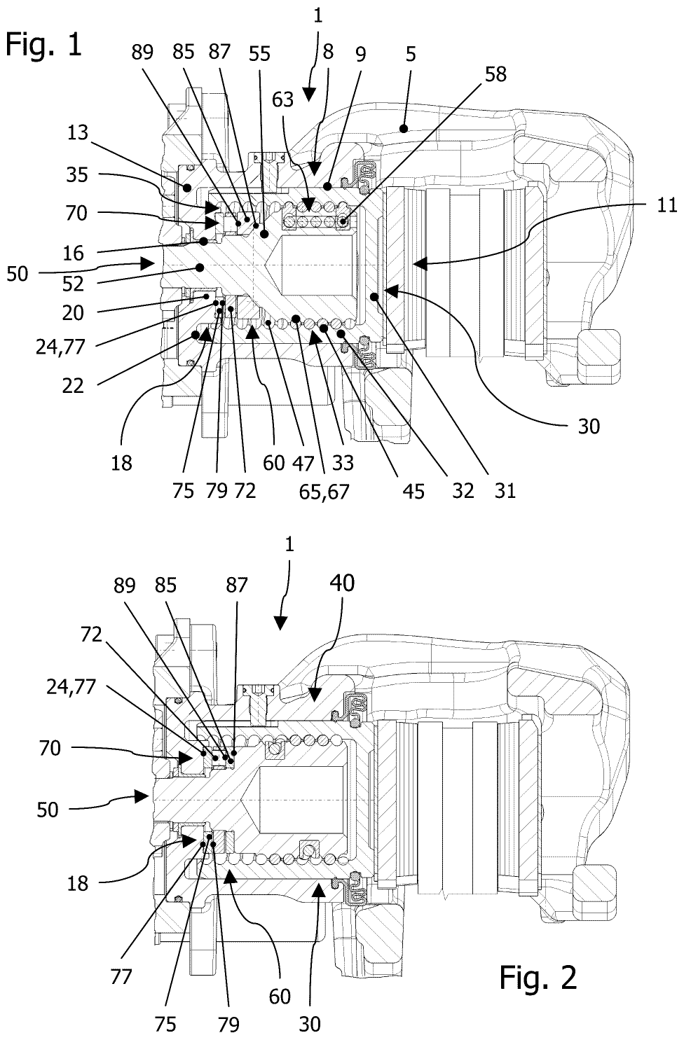

FIG. 1 illustrates a first exemplary arrangement of the brake actuator 1 according to the disclosure. The brake caliper housing 5 has a recess 8 in which the brake piston 30 is axially movably accommodated. The brake piston 30 is formed substantially from a cylindrical brake piston wall 32 and a closed end wall 31. The brake piston 30 projects with its end wall 31 out of the recess 8 through the recess opening 11, and during operation can be moved axially in the direction of the brake disc slot or in the opposite direction. The recess 8 has a cylindrical recess wall 9, and is delimited in the depth direction by a recess base 13. The brake piston 30 is in sliding contact, by way of the outer side of its brake piston wall 32, with the recess wall 9. The brake piston 30 is secured against rotation by a torque support. The brake piston wall 32 and the end wall 31 form an interior 35 of the brake piston 30, such that the brake piston 30 is open towards the recess base 13, that is to say towards the drive side. An internal thread flight 45 having a first raceway profile 47 is formed into the inner side 33 of the brake piston wall 32.

A drive spindle 50 is arranged in the interior 35 of the brake piston 30. The drive spindle 50 has a threaded portion 63 and a shaft 52. The threaded portion 63 and shaft 52 are connected to one another by a transition region 55. The shaft 52 projects out of the brake caliper housing 5, for the purposes of coupling to an electromechanical drive, through a shaft leadthrough 16 that extends through the recess base 13.

The shaft 52 is mounted for rotation by an axial roller bearing 70. The threaded portion 63 has a greater diameter than the shaft 52, such that the shaft 52 fits through the shaft leadthrough 16 and such that the threaded portion 63 can interact in terms of drive with the brake piston 30, which in the present case acts, as it were, as a spindle nut. For this purpose, an external thread flight 65 having a second raceway profile 67 is furthermore formed into the threaded portion 63.

The threaded portion 63 furthermore has a ball return guide via which the balls 58 that are guided movably between the internal thread flight 45 and the external thread flight 65 in accordance with the principle of a recirculating ball spindle drive are guided in a movement circuit in relation to the drive spindle. When the brake actuator 1 is actuated, the balls 58 move relative to the drive spindle 50 within the defined circuit. The drive spindle 50 rotates in a fixed position, whereas the brake piston 30 moves translationally and the balls 58 move continuously along the external thread flight 65 for as long as the brake piston 30 moves in one direction. The drive spindle 50, together with the brake piston 30 and the balls 58, forms a recirculating ball spindle drive 40.

In order that the recirculating ball spindle drive 40 can function, the drive spindle 50 is supported axially with respect to the brake caliper housing 5 via an axial bearing 70, which is designed in the present case as an axial roller bearing. For this purpose, the recess base 13 has a projection 20, which protrudes from a surface portion 22 of the recess base 13 into the interior 35. The projection 20, together with the region that protrudes into the interior 35, forms a first rolling bearing seat 18 which is positioned closer to the recess opening 11 than the surface portion 22 extending annularly around the projection 20. The shaft leadthrough 16 extends through the projection 20. The transition region 55 of the drive spindle 50 has a second rolling bearing seat 60, which in this exemplary arrangement is of domed form and is oriented obliquely both with respect to the axial direction and with respect to a plane running orthogonally to the axial direction and tapers in the direction of the shaft 52.

The cylindrical roller bearing 70 is arranged between the first rolling bearing seat 18 and the second rolling bearing seat 60. Said cylindrical roller bearing has a first bearing disc 75, having a first abutment surface 77 and a first raceway surface 79, and has a second bearing disc 85, having a second abutment surface 87 and a second raceway surface 89. The first bearing disc 75 lies with its first abutment surface 77 against the first rolling bearing seat 18. The second bearing disc 85 lies with its second abutment surface 87 against the second rolling bearing seat 60. The second abutment surface 87 is designed to correspond to the second rolling bearing seat 60. Said second abutment surface may also be of domed form. It may however also be of conical form. Rolling elements (in this case cylindrical rollers) 72 are arranged between the first bearing disc 75 and the second bearing disc 85, which rolling elements roll, between the two bearing discs 75, 85, on the first raceway 79 and on the second raceway 89 in accordance with the function of a rolling bearing. The first abutment surface 77 and the first raceway surface 79 are oriented orthogonally to the axial direction.

Since the return guide for the balls 58 is installed within the drive spindle 50 or the threaded portion 63, the drive spindle 50 does not need to extend through the end wall 31 of the brake piston 30 that acts as a spindle nut; the threaded portion 63 can also be relatively short in the axial direction. Thus, in turn, the rolling bearing 70 can be positioned in the interior 35. That is to say, when the brake piston 30 is in the retracted state as shown in FIG. 1, the cylindrical roller bearing 70 is situated entirely in the interior 35. The projection 20 has the effect that the support surface 24 of the first rolling bearing seat 18, which support surface is integrally connected to the first rolling bearing seat 18 and against which support surface the first abutment surface 77 of the first bearing disc 75 lies, is situated entirely in the interior 35 when the brake piston 30 is in the retracted position. In the retracted position, the end wall 31 of the brake piston 30 and the threaded portion 63 of the drive spindle 50 reach their minimum spacing to one another, but do not collide.

FIG. 2 illustrates a second exemplary arrangement of the brake actuator 1 according to the disclosure. This second exemplary arrangement differs from the first exemplary arrangement substantially by the form of the second rolling bearing seat 60 and the form of the second bearing disc 85. Therefore, only these differences will be discussed in the following description. As regards the rest of the design, reference is made to the description of the first exemplary arrangement. The difference in the case of the bearing disc 85 of the second exemplary arrangement lies in the fact that not only the second raceway surface 89 but also the second abutment surface 87 is oriented orthogonally to the axial direction. Accordingly, the second rolling bearing seat 60 is also oriented orthogonally to the axial direction. The axial bearing 70 can thus be made more compact, and provides very good axial support of the drive spindle 50. The orthogonal surfaces can also be produced more easily and inexpensively.

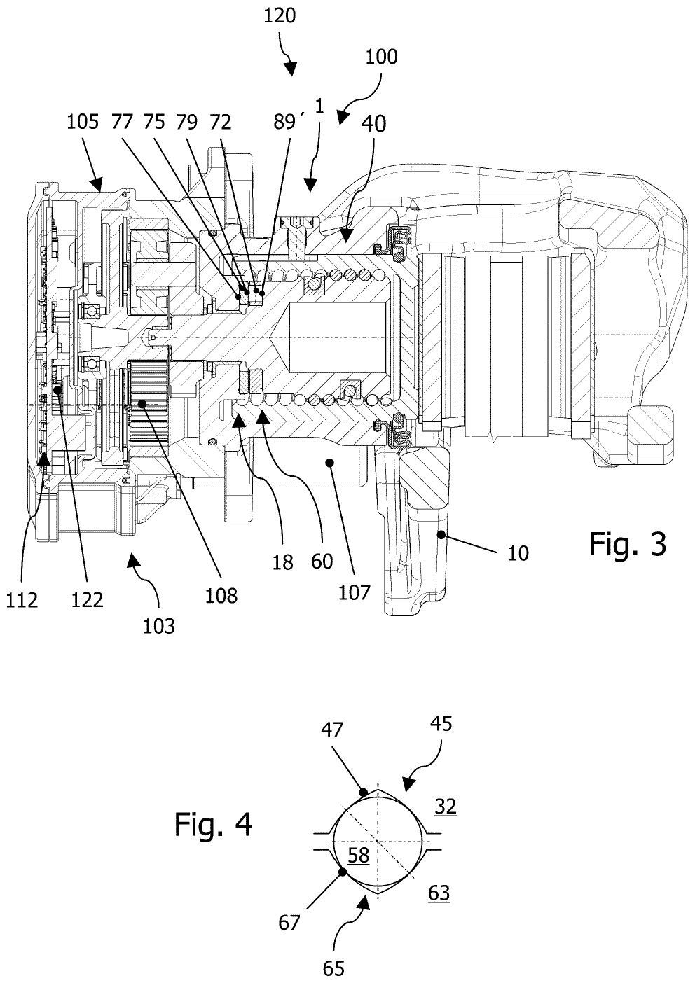

FIG. 3 illustrates a third exemplary embodiment of the brake actuator 1 according to the invention. Here, however, the brake actuator is illustrated in an installed state in the associated motor vehicle disc brake 100. FIG. 3 therefore also shows an exemplary embodiment of the motor vehicle disc brake 100 according to the disclosure and of the brake system 120 according to the disclosure. As regards the brake actuator 1, the third exemplary arrangement differs from the first exemplary arrangement substantially by the axial bearing 70 and the seating thereof between the brake caliper housing 5 and the drive spindle 50. Therefore, only these differences will be discussed in the following description of the brake actuator. As regards the rest of the design, reference is made to the description of the exemplary arrangements described above.

The first rolling bearing seat 18, the first bearing disc 75 and the arrangement thereof with respect to one another is identical to the first exemplary arrangement. The second rolling bearing seat 60 directly comprises the second raceway surface 89′, such that a second bearing disc is omitted in this exemplary arrangement. That is to say, the second raceway surface 89′ is an integral part of the drive spindle 50 or of the transition region 55. This provides additional compactness in terms of the axial structural length. The first abutment surface 77, the first raceway surface 79 and the second raceway surface 89′ are oriented orthogonally to the axial direction. The omission of the second bearing disc also results in an additional cost reduction.

In all three exemplary arrangement of the brake actuator, both the first raceway profile 47 and the second raceway profile 67 are designed as Gothic pointed arches. This raceway profile is illustrated in FIG. 4. The internal thread flight 45 of the brake piston wall 32 has a first raceway profile 47 designed as a Gothic pointed arch. The external thread flight 65 of the threaded portion 63 has a second raceway profile 67 also designed as a Gothic pointed arch. Thus, in all three exemplary arrangements, particularly good running accuracy of the recirculating ball spindle drive 40 and thus high functional accuracy are achieved, which is important for achieving that the end positions of the brake piston 30, for example the retracted position, are reliably assumed. The Gothic pointed arch profile is particularly advantageously combined with the second and third exemplary arrangements. Owing to the orthogonal orientation of the abutment and raceway surfaces and the reduction of the bearing components (omission of the second bearing disc), high running accuracy of the recirculating ball spindle drive is of importance (as already discussed above), and is promoted by the Gothic pointed arch profile.

FIG. 3 also illustrates an exemplary arrangement of the motor vehicle disc brake 100 according to the disclosure. An electromechanical drive 103 that comprises a gearbox assembly 105, an electric motor 107 and an electrical control unit 112 is installed on the drive side of the brake caliper housing 5. The output shaft 108 of the electric motor 107 is connected in terms of drive to the gearbox assembly 105. Said output shaft is indicated by a dash-dotted line. The drive spindle 50 and the output shaft 108 extend parallel and with a spacing to one another, such that the electric motor 107 axially overlaps the brake caliper housing 5 and the drive spindle 50.

The brake system 120 comprises an electronics component 122, which in this exemplary arrangement of the brake system 120 according to the disclosure is comprised by the electrical control unit 112. This results in short signal propagation times and thus fast and precise control of the electric motor, which in turn leads to reliable and precise positioning of the brake piston, for example into its end positions.

1. An electromechanically operable brake actuator for a motor vehicle disc brake, comprising:
a brake caliper housing which has a recess delimited by a recess wall, which extends into the brake caliper housing, and by a recess base, the recess having a recess opening situated opposite the recess base, and the recess base having a shaft leadthrough and a first rolling bearing seat;
a brake piston, which is mounted axially movably in the recess and is in direct contact with the recess wall, the brake piston having an end wall, with which the brake piston projects out of the brake caliper housing through the recess opening, and having a brake piston wall, which surrounds an interior and which has an inner side facing towards the interior, at least one internal thread flight being formed into the inner side;
a drive spindle which has a threaded portion with at least one external thread flight, has a shaft which projects through the shaft leadthrough, and has a second rolling bearing seat arranged in a transition region from the shaft to the threaded portion, the at least one external thread flight being operatively connected in terms of drive to the at least one internal thread flight such that the drive spindle and the brake piston act together as a spindle drive, and such that the brake piston can be moved axially between a retracted position and an extended position; and
a rolling bearing, which is arranged between the first and the second rolling bearing seat, the rolling bearing being situated within, the interior when the brake piston is in the retracted position.

2. The electromechanically operable brake actuator according to claim 1, wherein the at least one internal thread flight has a first raceway profile and the at least one external thread flight has a second raceway profile, wherein the first raceway profile and/or the second raceway profile is designed as a Gothic pointed arch.

3. The electromechanically operable brake actuator according to claim 1, wherein the rolling bearing has a first bearing disc having a first abutment surface, which lies against the first rolling bearing seat, and having a first raceway surface, on which the rolling elements comprised by the rolling bearing can roll,
wherein the rolling bearing has a second bearing disc having a second abutment surface, which lies against the second rolling bearing seat, and having a second raceway surface, on which the rolling elements comprised by the rolling bearing can roll,
wherein the first abutment surface and the first raceway surface, and/or wherein the second abutment surface and the second raceway surface, is oriented orthogonally to the axial direction.

4. The electromechanically operable brake actuator according to claim 1, wherein the rolling bearing has a first bearing disc having a first abutment surface, which lies against the first rolling bearing seat, and having a first raceway surface, on which the rolling elements comprised by the rolling bearing can roll,
wherein the second rolling bearing seat directly has a second raceway surface on which the rolling elements comprised by the rolling bearing can roll, wherein the first abutment surface and the first raceway surface, and/or wherein the second raceway surface, is oriented orthogonally to the axial direction.

5. The electromechanically operable brake actuator according to claim 1, wherein the recess base has a surface portion facing towards the recess and has a projection extending into the recess, wherein the projection comprises the first rolling bearing seat, and wherein the first rolling bearing seat is situated closer to the recess opening than the surface portion.

6. The electromechanically operable brake actuator according to claim 5, wherein the projection is cylindrical and wherein the surface portion is arranged annularly around the projection and/or wherein the projection has the shaft leadthrough.

7. The electromechanically operable brake actuator according to claim 1, wherein the first rolling bearing seat has a support surface for directly supporting the rolling bearing, wherein the support surface is situated entirely within the interior when the brake piston is in the retracted position.

8. A motor vehicle disc brake comprising a brake carrier, comprising an electromechanical drive that has a gearbox assembly and an electric motor, comprising a brake actuator according to claim 1 that is operable by the electromechanical drive, and comprising an electrical control unit for controlling the electric motor.

9. The motor vehicle disc brake according to claim 8, wherein the electric motor has an output shaft, and wherein the output shaft and the drive spindle extend parallel to one another and are spaced apart from one another.

10. The brake system comprising a motor vehicle disc brake according to claim 8 and comprising at least one electronics component, wherein the electronics component is configured or configurable to control the electric motor such that the brake piston can be moved into the retracted position and/or into the extended position.

11. The brake system according to claim 10, wherein the electronics component is comprised by the electrical control unit, and/or wherein the electric motor is an electronically commutated DC motor.

12. The motor vehicle disc brake according to claim 9, wherein the output shaft and the drive spindle are spaced apart from one another such that the electric motor and the brake caliper housing axially overlap.

13. The electromechanically operable brake actuator according to claim 2, wherein the rolling bearing has a first bearing disc having a first abutment surface, which lies against the first rolling bearing seat, and having a first raceway surface, on which the rolling elements comprised by the rolling bearing can roll,
wherein the rolling bearing has a second bearing disc having a second abutment surface, which lies against the second rolling bearing seat, and having a second raceway surface, on which the rolling elements comprised by the rolling bearing can roll
wherein the first abutment surface and the first raceway surface, and/or wherein the second abutment surface and the second raceway surface, is oriented orthogonally to the axial direction.

14. The electromechanically operable brake actuator according to claim 2, wherein the rolling bearing has a first bearing disc having a first abutment surface, which lies against the first rolling bearing seat, and having a first raceway surface, on which the rolling elements comprised by the rolling bearing can roll,
wherein the second rolling bearing seat directly has a second raceway surface on which the rolling elements comprised by the rolling bearing can roll, wherein the first abutment surface and the first raceway surface, and/or wherein the second raceway surface, is oriented orthogonally to the axial direction.

15. The electromechanically operable brake actuator according to claim 2, wherein the recess base has a surface portion facing towards the recess and has a projection extending into the recess, wherein the projection comprises the first rolling bearing seat, and wherein the first rolling bearing seat is situated closer to the recess opening than the surface portion.

16. The electromechanically operable brake actuator according to claim 2, wherein the first rolling bearing seat has a support surface for directly supporting the rolling bearing, wherein the support surface is situated entirely within the interior when the brake piston is in the retracted position.
